(19) United States
(12) Patent Application Publication
(10) Pub. No.: US 2025/0182161 A1
(43) Pub. Date: Jun. 5, 2025

(54) SYSTEM AND METHOD FOR SMART PROGRAMMATIC ADVERTISEMENT SCHEDULING IN DIGITAL SIGNAGE NETWORK

(71) Applicant: Wipro Limited, Bangalore (IN)

(72) Inventors: Manish Verma, Bangalore (IN); Jagan Mohan Gorthi, Bangalore (IN)

(73) Assignee: Wipro Limited, Bangalore (IN)

(21) Appl. No.: 18/790,864

(22) Filed: Jul. 31, 2024

(30) Foreign Application Priority Data
Nov. 30, 2023 (IN) 202341081592

(51) Int. Cl. G06Q 30/0251; G06Q 30/0204; G06Q 30/0242

(52) U.S. Cl. CPC G06Q 30/0264; G06Q 30/0204; G06Q 30/0242

(57) ABSTRACT

The present invention relates to method and system to smart programmatic advertisement scheduling on digital screens of a digital signage network. The system is configured to obtain attributes associated with each of the digital screens. The system is configured to receive the scheduling data associated with the one or more advertisements. The system is configured to generate a performance report associated with the advertisements. The system is configured to generate advertisement contextual schedule data associated with the advertisements for digital screens of the digital signage network based on the advertisement product taxonomy, the performance report, the attributes, and the scheduling data. The system is configured to provide the advertisements to the plurality of digital screens of the digital signage network based on the contextual advertisement schedule data.

### TECHNICAL FIELD

The present invention relates to a method and a system for smart programmatic advertisement scheduling, and more particularly to a method and a system for smart programmatic advertisement scheduling of advertisements of a plurality of digital screens in a digital signage network.

### BACKGROUND

Digital out-of-home (DOOH) advertising has become an increasingly popular medium for reaching audiences in public spaces, including retail stores, transportation hubs, sports venues, and urban environments. With the transition from traditional static billboards to dynamic digital screens, advertisers have gained the ability to deliver targeted and engaging content to viewers. However, managing programmatic advertisement scheduling across DOOH signage networks presents several technical challenges that need to be addressed for optimal performance and revenue generation.

Traditionally, signage for businesses and others was static in nature and was relatively expensive and time-consuming to change. Recently, Digital Out Of Home (DOOH), such as electronic billboards has begun replacing static signage. Such DOOH may also be referred to as a plurality of digital screens. Electronic signage can range in size from small personal displays such as a Liquid Crystal Display (LCD), Light Emitting Diode (LED) display, plasma display, a projected display, and extremely large displays in public locations like roadside signs, the multitude of displays at Times Square, and the like.

The plurality of digital screens is generally used to show news, advertisements, local announcements, and other multimedia content in public venues such as restaurants or shopping malls. In recent years, digital signage industry has experienced tremendous growth, and it is now only second to the Internet advertising industry in terms of annual revenue growth.

The plurality of digital screens are connected in digital signage network whose primary or secondary function is to increase revenue through advertising e.g. Retailers may use the plurality of digital screens to let customers know about discounts or promotions. Sports or Entertainment venues use such screens to display important information to patrons as well as drive sponsorship activations and promotions. As venues increase their number of the plurality of digital screens, they are shifting towards becoming a fully operational digital signage network where there is a huge opportunity to increase overall revenue working with advertisers who may be relevant to their audiences. Thus, there is a need for an intelligent system to help efficiently schedule programmatic advertisement across their plurality of digital screens.

Further, the digital signage network operations for advertising are a lucrative marketplace and there is a need for monetizing it to its full potential. Even if a digital signage network is running existing ad campaigns, there's a chance that the plurality of digital screens have unsold inventory or unscheduled advertising slots. In the current digital signage networks, non-endemic or programmatic advertisements need to be scheduled manually based on day parting schedule or based on the SCTE standard markers in the content being delivered to the plurality of digital screens. In either case, there is a loss of key marketing dollars from buyers who value the audience on the plurality of digital screens that are served. Maximizing revenue is the key aspect in driving advertisements across the digital signage network and hence there is a need of an efficient & intelligent system to schedule most relevant advertisement for a particular digital screen in the digital signage network.

One of the key technical problems in DOOH advertising is the inefficient utilization of ad inventory. Traditional scheduling methods often rely on manual processes or static schedules that do not adapt to changes in audience behavior, ad demand, or environmental factors. As a result, ad slots may remain unfilled or underutilized, leading to missed revenue opportunities for screen owners and advertisers alike.

Another technical challenge is the lack of context-awareness in ad scheduling. Without real-time data on audience demographics, location-based trends, and content relevance, ads may be displayed to the wrong audience at the wrong time, reducing their effectiveness and diminishing the overall value of the advertising network.

Additionally, the fragmentation of ad inventory across multiple screens, locations, and ad providers complicates the management and optimization of ad scheduling. Screen owners often struggle to balance competing priorities, such as maximizing revenue, ensuring ad relevance, and maintaining a positive viewer experience, while ad providers face challenges in efficiently delivering their content to the right audience at the right time.

Furthermore, the absence of automated mechanisms for monitoring ad performance and adjusting ad schedules in real-time limits the ability of DOOH networks to adapt to changing market conditions and audience preferences. Without timely feedback on ad effectiveness and viewer engagement, screen owners and ad providers may miss opportunities to optimize their advertising campaigns and maximize their returns on investment.

In addition, conventional plurality of digital screens faces multiple challenges. For example, in conventional plurality of digital screens, Ad slots are not filled due to lack of Ads and Ad slots duration is not sufficiently consumed by Ad served. Further, conventional digital screens are not flexible for selecting the right Ad provider for Ad slot. Additionally, conventional digital screens do not provide relevance of an Ad in an Ad slot due to lack of context.

Conventional methods for managing digital out-of-home (DOOH) advertising often rely on manual scheduling processes and static ad placements, leading to inefficiencies and missed opportunities for revenue generation. Manual scheduling is time-consuming and lacks flexibility to adapt to changing audience dynamics or market conditions, resulting in suboptimal ad placements and underutilized ad inventory. Static ad placements fail to target audiences effectively, as they do not consider real-time audience data or contextual factors, leading to reduced engagement and effectiveness of ad campaigns. Additionally, limited use of data analytics tools further exacerbates these challenges, as they primarily focus on post-campaign analysis rather than real-time optimization, and lack predictive capabilities to anticipate future trends or optimize ad placements based on forecasted audience behavior. Overall, conventional methods suffer from inefficiency, poor targeting, and limited scalability to optimize ad scheduling and maximize revenue within DOOH signage networks.

To overcome shortcomings of the conventional plurality of digital screens, multiple solutions are provided to the digital signage network. In such solutions, the digital signage network requests the Ads from Ads Providers based on contextual data like Audience Profile, location of the screens and the time of the day/week/month/year and/or specific events. However, such solutions do not consider whether the request for the Ad was fulfilled with a relevant (contextual) Ad or not. Such solutions also do not consider the business rules of Ads Providers and Screen Owners. The conventional solutions also do not consider the context of the screen on a particular location, screens position in a larger display, and the like. Current solutions do not update the Ad slots (timing) based on historical trends.

In summary, the technical problems facing the DOOH advertising industry include inefficient ad inventory management, lack of context-awareness in ad scheduling, fragmentation of ad inventory, and the absence of real-time optimization mechanisms. Addressing these technical challenges requires technical solutions that leverage data analytics, artificial intelligence, and automation to optimize ad scheduling, maximize revenue, and enhance audience engagement within DOOH signage networks.

As a result, there is a need for a system and a method for efficiently managing ad scheduling, maximizing revenue potential, and enhancing audience engagement within the digital screens of advertising ecosystem.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to embodiments illustrated herein, there may be provided a system that includes an application server, an Advertisement (AD) database server, a plurality of digital screens, and a communication network configured to manage content on the plurality of digital screens of a digital signage network. The system may be configured to obtain one or more attributes associated with each of the plurality of digital screens. The system may be configured to receive scheduling data associated with the one or more advertisements. The system may be configured to generate a proof of performance report associated with the one or more advertisements. The system may be configured to generate advertisement contextual schedule data associated with the one or more advertisements for the plurality of digital screens of the digital signage network based on the advertisement product taxonomy, the proof of performance report, the one or more attributes, and the scheduling data. The system may be configured to provide the one or more advertisements to the plurality of digital screens of the digital signage network based on the contextual advertisement schedule data.

According to embodiments illustrated herein, there is provided a method for smart programmatic advertisement scheduling on a plurality of digital screens of a digital signage network. The method may be implemented by an application server including one or more processors and a memory communicatively coupled to the processor and the memory is configured to store processor-executable instructions. The method may include obtaining one or more attributes associated with each of the plurality of digital screens. The method may include receiving the content comprising one or more advertisements and scheduling data associated with the content. The method may include generating a proof of performance report associated with one or more advertisements. The method may include generating advertisement contextual schedule data associated with the one or more advertisements for the plurality of digital screens of the digital signage network based on the one or more advertisements, the proof of performance report, the one or more attributes, and the scheduling data. The method may include providing one or more advertisements to the plurality of digital screens of the digital signage network based on the contextual advertisement schedule data.

According to embodiments illustrated herein, there is provided a non-transitory computer-readable medium storing computer-executable instructions for smart programmatic advertisement scheduling on a plurality of digital screens of a digital signage network is disclosed. In one example, the stored instructions, when executed by a processor, cause the processor to perform operations including obtaining one or more attributes associated with each of the plurality of digital screens. Further, the processor is configured to receive the scheduling data associated with the one or more advertisements. Further, the processor is configured to generate a proof of performance report associated with the one or more advertisements. Further, the processor is configured to generate advertisement contextual schedule data associated with the one or more advertisements for the plurality of digital screens of the digital signage network based on the advertisement product taxonomy, the proof of performance report, the one or more attributes, and the scheduling data. Further, the processor is configured to provide one or more advertisements to the plurality of digital screens of the digital signage network based on the contextual advertisement schedule data.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 is a block diagram that illustrates a system environment in which various embodiments of the method and the system may be implemented.

FIG. 2 is a block diagram that illustrates an application server configured for smart programmatic advertisement scheduling on a plurality of digital screens of a digital signage network, in accordance with an embodiment of present invention.

FIG. 3 is a flowchart that illustrates a method for smart programmatic advertisement scheduling on a plurality of digital screens of a digital signage network, in accordance with an embodiment of present invention; and

FIG. 4 illustrates a block diagram of an exemplary computer system for implementing embodiments consistent with the present disclosure.

FIG. 5 illustrates an exemplary diagram of an Ad product taxonomy, in accordance with an embodiment of present invention.

FIG. 6 illustrates an exemplary diagram of an audience taxonomy, in accordance with an embodiment of present invention.

FIG. 7 illustrates a block diagram of a predictive model, according to an embodiment of present invention.

### DETAILED DESCRIPTION

The present disclosure may be best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

The present disclosure relates to a system for smart programmatic advertisement scheduling to be displayed on Digital Out Of Home (DOOH) screens. The system is implemented in a DOOH Digital Signage Network and configured to implement an Artificial Intelligence (AI) driven intelligent system to schedule programmatic advertisement by selecting most appropriate Ad Providers and the type of Ads to be displayed at specific digital screens. The proposed disclosure also addresses the problem by generating the context which helps in choosing the most suitable advertisement which maximizes the ad revenue and filling the ad inventory.

The system considers whether the request for the Ad was fulfilled with a relevant (contextual) Ad or not. The system further considers the business rules of Ads providers and screen owners. Further, the system considers the context of the screen present in a particular location, screens position in a larger display etc. The system further enables updating the Ad slots (timing) based on historical trends.

It is an object of the present disclosure to optimize scheduling of one or more advertisements across a plurality of digital screens of a digital signage network. Another objective of the present disclosure is to maximize revenue generation for screen owners and advertisement providers within the digital signage network. Yet another objective of the present disclosure is to enhance the relevance and effectiveness of advertisements displayed on the plurality of digital screens of the digital signage network. Yet another objective of the present disclosure is to enable real-time optimization and adaptation of advertisement schedules based on changing market conditions, audience behavior, and advertisements provider performance.

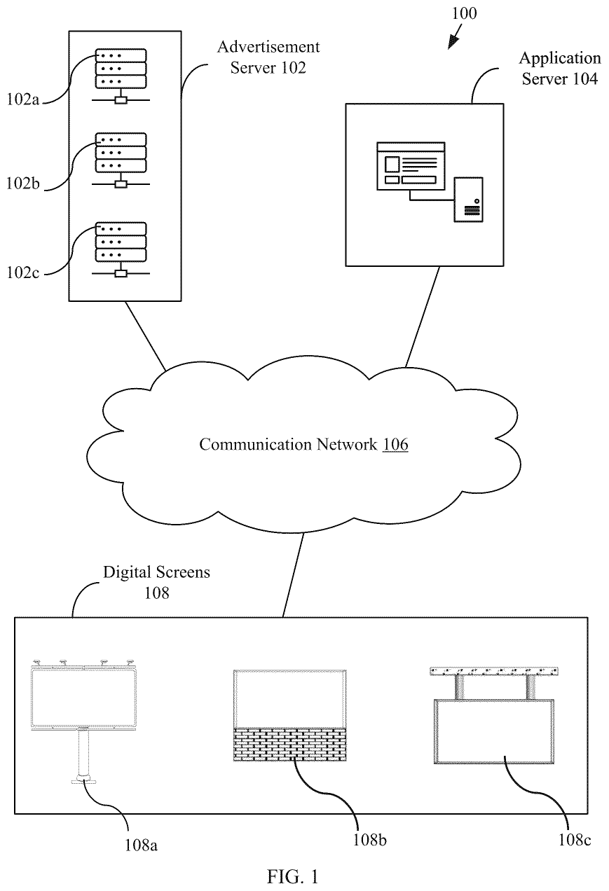

FIG. 1 is a block diagram that illustrates a system environment 100 in which various embodiments of the method and the system may be implemented. The system environment 100 typically includes a plurality of advertisement servers 102 associated with one or more advertisement providers, an application server 104, a communication network 106, and a plurality of digital screens 108 which are part of a digital signage network. The plurality of advertisement servers 102, the application server 104, and the plurality of digital screens 108 are typically communicatively coupled with each other via the communication network 106. In an embodiment, the application server 104 may communicate with the database server 104, and the plurality of advertisement servers 102 using one or more protocols such as, but not limited to, Open Database Connectivity (ODBC) protocol and Java Database Connectivity (JDBC) protocol.

The plurality of advertisement servers 102 associated with one or more advertisement providers may comprise one or more processors for providing advertisements (Ads) to be displayed on the plurality of digital screens 108. The plurality of advertisement servers 102 may represent any single computing system with dedicated hardware and software, multiple computing systems clustered together (e.g., a server farm), a portion of shared resources on one or more computing systems (e.g., virtual server), or any combination thereof.

The plurality of advertisement servers 102 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. The plurality of advertisement servers 102 may include one or more virtual machines running virtual operating systems, or other computing architectures involving virtualization such as one or more flexible pools of logical storage devices that can be virtualized to maintain virtual storage devices for the server. In various embodiments, the plurality of advertisement servers 102 may be adapted to run one or more services or software applications that provide the functionality described in the foregoing disclosure.

The computing systems in the plurality of advertisement servers 102 may run one or more operating systems including any of those discussed above, as well as any commercially available server operating system. The plurality of advertisement servers 102 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, Sybase®, IBM® (International Business Machines), and the like.

In one embodiment, the plurality of advertisement servers 102 may provide one or more Ads to be displayed on the plurality of digital screens 108. For example, the plurality of digital screens 108 may send a request for an Ad to the communication network 106. Any activity of a user on the plurality of digital screens 108 can initiate sending data related to the plurality of digital screens 108 and other information to the plurality of advertisement servers 102. The plurality of advertisement servers 102 may analyze such data and accordingly provide the Ads to the plurality of digital screens 108 through the communication network 106.

The plurality of advertisement servers 102 may be configured to store one or more attributes associated with each of the plurality of digital screens 108 of the digital signage network. The plurality of advertisement servers 102 associated with the one or more advertisement providers may be configured to store the proof of performance report associated with the one or more advertisements. The plurality of advertisement servers 102 may be configured to store advertisement contextual schedule data associated with the one or more advertisements for the plurality of digital screens 108 of the digital signage network.

In an embodiment, the application server 104 may refer to a computing device or a software framework hosting an application or a software service. In an embodiment, the application server 104 may be implemented to execute procedures such as, but not limited to, programs, routines, or scripts stored in one or more memories for supporting the hosted application or the software service. In an embodiment, the hosted application or the software service may be configured to perform one or more predetermined operations. The application server 104 may be realized through various types of application servers such as, but are not limited to, a Java application server, a.NET framework application server, a Base4 application server, a PHP framework application server, or any other application server framework.

In an embodiment, the application server 104 may be configured to obtain one or more attributes associated with each of the plurality of digital screens. The application server 104 may be further configured to receive the scheduling data associated with the one or more advertisements of each of the plurality of digital screens. The application server 104 may be further configured to generate a proof of performance report associated with the one or more advertisements. The application server 104 may be further configured to use metrics of advertisement delivery for preparing the Proof of Performance (POP) Report for each advertisement request. The application server 104 may be further configured to generate the Advertisement Performance Report (APR) for each advertisement providers. The APR report may comprise, but not limited to, an Ad provider ID, an Ad product taxonomy (shared with the Ad provider in the Ad request), an Ad product taxonomy (returned by the Ad provider in the response to the digital Screen), a probability of the Ad provider (based on previous data from the Ad provider giving an Ad).

The application server 104 may be further configured to generate advertisement contextual schedule data associated with the one or more advertisements for the plurality of digital screens of the digital signage network based on the advertisement product taxonomy, the proof of performance report, the one or more attributes, and the scheduling data. The application server 104 may be further configured to provide the one or more advertisements to the plurality of digital screens of the digital signage network based on the contextual advertisement schedule data.

The application server 104 may be further configured to recommend one or more alterations to the advertisement contextual schedule data based on historical data of the proof of performance report using at least one of a first prediction model and a second prediction model. In an embodiment, the application server 104 may be configured to determine a necessity to recommend the one or more alterations to the advertisement contextual schedule data based on the historical data of the proof of performance report using the first prediction model. In an embodiment, the application server 104 may be configured to predict the advertisement product taxonomy and the one or more advertisement provider for each of the plurality of digital screens using the second prediction model.

The application server 104 may be further configured to segment and label the audience data based on demographic information of target audience. The application server 104 may be further configured to prepare an audience taxonomy corresponding to each of the plurality of digital screens based on the segmented and labelled audience data. The application server 104 may be further configured to generate the proof of performance report associated with each of the one or more advertisements for each of the advertisement provider. The application server 104 may be further configured to select at least one of a set of advertisement providers from the one or more advertisement providers, a type of advertisement for at least one of the plurality of digital screens of a digital signage network, a time duration, and a time instant for displaying the one or more advertisements. The application server 104 may be further configured to maximize advertising revenue and filling advertisement inventory based on the generated advertisement contextual schedule data. The application server 104 may be further configured to determine a relevance of the scheduling data based on the generated advertisement contextual schedule data. The application server 104 may be further configured to transmit interaction data associated with an activity of one or more target audiences on each of the plurality of digital screens to the one or more advertisement provider. The application server 104 may be further configured to analyze the interaction data to update the advertisement contextual schedule data.

A person having ordinary skill in the art will appreciate that the scope of the disclosure is not limited to realizing the application server 104 and the plurality of advertisement servers 102 as separate entities. In an embodiment, the application server 104 may be realized as an application program installed on and/or running on the plurality of advertisement servers 102 and vice versa without departing from the scope of the disclosure.

In an embodiment, the communication network 106 may correspond to a communication medium through which the application server 104, the plurality of advertisement servers 102, and the plurality of digital screens 108 may communicate with each other. Such a communication may be performed, in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared IR), IEEE 802.11, 802.16, 2G, 3G, 4G, 5G, 6G, 7G cellular communication protocols, and/or Bluetooth (BT) communication protocols. The communication network 106 may include, but is not limited to, the Internet, a cloud network, a Wireless Fidelity (Wi-Fi) network, a Wireless Local Area Network (WLAN), a Local Area Network (LAN), a telephone line (POTS), and/or a Metropolitan Area Network (MAN).

The plurality of digital screens 108 may comprise suitable logic, circuitry, interfaces, and/or code that may be configured to provide the one or more advertisements to the plurality of digital screens 108 of the digital signage network based on the contextual advertisement schedule data. The plurality of digital screens 108 may represent one of a variety of other rendering devices (e.g., a single pole support type screen 108a, a base type screen 108b, a hanging type screen 108c, an inlaid type screen, a double board support screen, etc.) having hardware and software (e.g. web browser application) capable of processing and displaying information (e.g., web page, graphical user interface, etc.), and communicating information (e.g., web page request, user activity, campaign settings, etc.) over the communication network 106.

The plurality of digital screens 108 may comprise a database for each plurality of digital screens 108. The database may comprise one or more attributes related to the plurality of digital screens 108. In an embodiment, the attributes related to the plurality of digital screens 108 may comprise, but not limited to, a screen identifier (ID), a size of the screen size, a resolution of the screen, an orientation of the screen (vertical or horizontal), a screen site location, and a position of the screen in the site. Such one or more attributes may be provided to the application server 104 for further processing. The database for each of the plurality of digital screens may be stored in the application server.

In another embodiment, the plurality of digital screens 108 may include various types of rendering systems such as PA devices, televisions, portable handheld devices, general purpose computers such as personal computers and laptops, workstation computers, wearable devices, gaming systems, thin clients, various messaging devices, sensors or other sensing devices, any display screen of an electronic device, and the like. In an embodiment, the plurality of digital screens 108 may be powered using LCD, LED, OLED, QLED and the like technologies. These computing devices may run various types and versions of software applications and operating systems (e.g., Microsoft Windows®, Apple Macintosh®, UNIX® or

UNIX-like operating systems, Linux or Linux-like operating systems such as Google Chrome™ OS) including various mobile operating systems (e.g., Microsoft Windows Mobile®, iOS®, Windows Phone®, Android™, BlackBerry®, Palm OS®). Portable handheld devices may include cellular phones, smartphones, (e.g., an iPhone®), tablets (e.g., iPad®), personal digital assistants (PDAs), and the like. Wearable devices may include Google Glass® head mounted display, and other devices. Gaming systems may include various handheld gaming devices, internet-enabled gaming devices (e.g., a Microsoft Xbox® gaming console with or without a Kinect® gesture input device, Sony PlayStation® system, various gaming systems provided by Nintendo®, and others), and the like. The client devices may be capable of executing various different applications such as various Internet-related apps, communication applications (e.g., E-mail applications, short message service (SMS) applications) and may use various communication protocols.

In operation, the proof of performance report associated with each of the one or more advertisements for each of the advertisement provider may be represented using the table A as shown below.

TABLE A

| Slot | | Plan Start | Plan | Actual Start | Actual |
|---|---|---|---|---|---|
| No. | Date | time | End time | time | End time |
| 1 | Feb. 29^{th}, 2024 | 9:00:00 | 9:00:10 | 9:00:00 | 9:00:05 |
| 2 | Feb. 29^{th}, 2024 | 9:00:10 | 9:00:20 | 9:00:10 | 9:00:18 |
| 3 | Feb. 29^{th}, 2024 | 9:30:00 | 9:30:10 | 9:30:00 | 9:30:05 |
| N | . . | | | | |

Based on the proof of performance report, the application server 104 may be configured to detect anomalies within the planned advertisement schedule and the actual displayed advertisement. Below table B represents the detected anomalies.

TABLE B

| Slot No. | Start time | End time | Anomaly |
|---|---|---|---|
| 1 | 9:00:00 | 9:00:10 | True |
| 2 | 9:00:10 | 9:00:20 | False |
| 3 | 9:30:00 | 9:30:10 | False |
| N | | | |

In an embodiment, the above proof of performance report illustrated in table A and the detected anomalies in table B may be used as a training data for the first prediction model. The first prediction model may be trained based on the table A and table B. After the training, an input schedule for each of the plurality of digital screens may be given as input to the first prediction model. Below table C represents the input schedule.

TABLE C

| Slot No. | Date | Start time | End time |
|---|---|---|---|
| 1 | 1^{st} Mar. 2024 | 9:00:00 | 9:00:10 |
| 2 | 1^{st} Mar. 2024 | 9:00:10 | 9:00:20 |
| 3 | 1^{st} Mar. 2024 | 9:30:00 | 9:30:10 |
| N | . . | | |

Based on the input, the first prediction model may be configured to generate output as shown in the below table D

TABLE D

| Slot No. | Date | Start time | End time |
|---|---|---|---|
| 1 | 1^{st} Mar. 2024 | 9:00:00 | 9:00:05 |
| 2 | 1^{st} Mar. 2024 | 9:00:05 | 9:00:10 |
| 3 | 1^{st} Mar. 2024 | 9:00:10 | 9:00:20 |
| 4 | 1^{st} Mar. 2024 | 9:30:00 | 9:30:10 |
| N | . . | | |

As illustrated above, the application server 104 may be configured to receive the scheduling data for each of the plurality of digital screens and for each slot the first prediction model may be configured to check the anomalies. If one or more anomalies are detected then the slot timing may be altered/split. If one or more anomalies are not detected then the existing slot duration may be followed.

Further, the second prediction model of the application server 104 may be configured to output advertisement provider ID and advertisement product taxonomy based on fulfillment of advertisement for a particular screen by a plurality of advertisement providers and relevance of an advertisement by each of the plurality of advertisement providers for the particular slot.

In an embodiment the table E, table F, table G, and table H shown below may be used to generate the output i.e. advertisement provider ID and advertisement product taxonomy. The % here is determined based on the product Taxonomy that is sent to the advertisement provider and what product taxonomy was received along with the one or more advertisements. Based on the %, the context evaluator will use this as one of the inputs to determine which advertisement provider(s) needs be requested for an advertisement.

TABLE E

| Slot No. | Ad Provider 1 | Ad Provider 2 | Ad Provider 3 | Ad Provider n |
|---|---|---|---|---|
| 1 | 50% | 60% | 25% | |
| 2 | 50% | 40% | 35% | |
| 3 | 40% | 60% | 55% | |
| N | . . | | | |

TABLE F

| Slot No. | Ad Provider 1 | Ad Provider 2 | Ad Provider 3 | Ad Provider n |
|---|---|---|---|---|
| 1 | 10% | 70% | 25% | |
| 2 | 80% | 50% | 60% | |
| 3 | 40% | 60% | 55% | |
| N | . . | | | |

TABLE G

| Screen | | | | Geo | Venue |
|---|---|---|---|---|---|
| ID | Screen Type | Resolution | Orientation | Location | location |
| 1 | TV Panel | UHD | Horizontal | Lat/Long | Zone 1 |
| 2 | LED Panel | HD | Horizontal | Lat/Long | Zone 2 |
| 3 | Touch Screen | HD | Vertical | Lat/Long | Zone 1 |
| 4 | Kiosk | SD | Vertical | Lat/Long | Zone 2 |
| n | . . . | . . . | . . . | . . . | . . . |

TABLE H

| Slot No. | Screen 1 | Screen 2 | Screen 3 | Screen n |
|---|---|---|---|---|
| 1 | (1, 48, 49) | (1, 48, 50) | (1, 48, 50) | . . |
| 2 | (1, 48, 50) | (1, 48, 50) | (1, 48, 49) | . . |
| 3 | (1, 48, 49) | (1, 48, 49) | (1, 48, 49) | . . |
| N | . . | . . | . . | . . . |

The output i.e. advertisement provider ID and advertisement product taxonomy may be represented as shown in the below table I

TABLE I

| Slot | Ad. Provider Number | Ad. product Taxonomy |
|---|---|---|
| 1 | 2 | (1123, 1124, 1125), |
| 2 | 3 | (1123, 1124, 1126), |
| 3 | 2 | (1123, 1124, 1125), |
| 4 | 4 | (1123, 1124, 1126), |
| n | . . . | . . . |

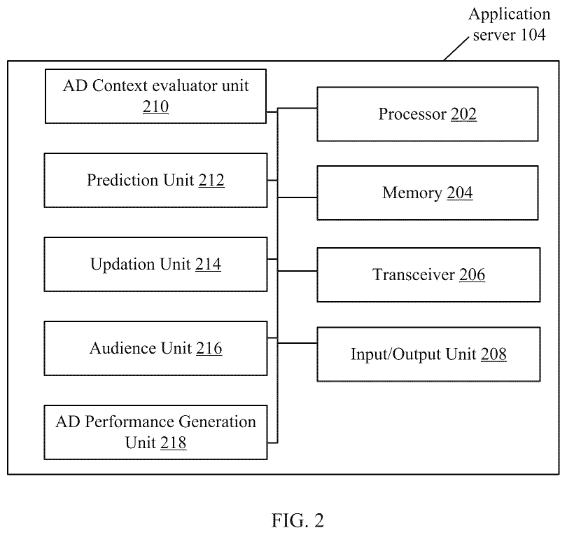

FIG. 2 is a block diagram that illustrates an application server 104 configured for smart programmatic advertisement scheduling on a plurality of digital screens of a digital signage network, in accordance with an embodiment of present invention. FIG. 2 is explained in conjunction with elements from FIG. 1. Here, the application server 104 preferably includes a processor 202, a memory 204, a transceiver 206, an input/output unit 208, an AD context evaluator unit 210, a prediction unit 212, an updation unit 214, an audience unit 216, and an AD performance generation unit 218. The processor 202 is further preferably communicatively coupled to the memory 204, the transceiver 206, the input/output unit 208, the AD context evaluator unit 210, the prediction unit 212, the updation unit 214, the audience unit 216, and the AD performance generation unit 218, while the transceiver 206 is preferably communicatively coupled to the communication network 106.

The processor 202 comprises suitable logic, circuitry, interfaces, and/or code that may be configured to execute a set of instructions stored in the memory 204, and may be implemented based on several processor technologies known in the art. The processor 202 works in coordination with the transceiver 206, the input/output unit 208, the AD context evaluator unit 210, the prediction unit 212, the updation unit 214, the audience unit 216, and the AD performance generation unit 218 for smart programmatic advertisement scheduling on the plurality of digital screens 108 of the digital signage network. Examples of the processor 202 include, but not limited to, an X86-based processor, a Reduced Instruction Set Computing (RISC) processor, an Application-Specific Integrated Circuit (ASIC) processor, and a Complex Instruction Set Computing (CISC) processor, for example.

The memory 204 comprises suitable logic, circuitry, interfaces, and/or code that may be configured to store the set of instructions, which are executed by the processor 202. Preferably, the memory 204 is configured to store one or more programs, routines, or scripts that are executed in coordination with the processor 202. Additionally, the memory 204 may be implemented based on a Random Access Memory (RAM), a Read-Only Memory (ROM), a Hard Disk Drive (HDD), a storage server, and/or a Secure Digital (SD) card.

The transceiver 206 comprises suitable logic, circuitry, interfaces, and/or code that may be configured to obtain one or more attributes associated with each of the plurality of digital screens 108. The transceiver 206 is preferably configured to receive the scheduling data associated with the one or more advertisements. The transceiver 206 is preferably configured to receive scheduling data associated with the one or more advertisements and receive the proof of performance report associated with each of the one or more advertisements for each of the advertisement provider. The transceiver 206 is preferably configured to receive interaction data associated with an activity of one or more target audiences on each of the plurality of digital screens to the one or more advertisement provider.

The transceiver 206 may implement one or more known technologies to support wired or wireless communication with the communication network 106. In an embodiment, the transceiver 206 may include, but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. Also, the transceiver 206 may communicate via wireless communication with networks, such as the Internet, an Intranet and/or a wireless network, such as a cellular telephone network, a wireless local area network (LAN) and/or a metropolitan area network (MAN). Accordingly, the wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VOIP), Wi-MAX, a protocol for email, instant messaging, and/or Short Message Service (SMS).

The input/output unit 208 comprises suitable logic, circuitry, interfaces, and/or code that may be configured to provide one or more inputs for smart programmatic advertisement scheduling on the plurality of digital screens of the digital signage network and for providing the one or more advertisements to the plurality of digital screens 108 of the digital signage network based on the contextual advertisement schedule data. The input/output unit 208 comprises of various input and output devices that are configured to communicate with the processor 202. Examples of the input devices include, but are not limited to, a keyboard, a mouse, a joystick, a touch screen, a microphone, a camera, and/or a docking station. Examples of the output devices include, but are not limited to, a display screen and/or a speaker.

The AD context evaluator unit 210 comprises suitable logic, circuitry, interfaces, and/or code that may be configured to generate advertisement contextual schedule data associated with the one or more advertisements for the plurality of digital screens of the digital signage network based on the advertisement product taxonomy, the proof of performance report, the one or more attributes, and the scheduling data. The AD context evaluator unit 210 may be configured to select at least one of a set of advertisement providers from the one or more advertisement providers, a type of advertisement for at least one of the plurality of digital screens of a digital signage network, a time duration, and a time instant for displaying the one or more advertisements.

The prediction unit 212 comprises suitable logic, circuitry, interfaces, and/or code that may be configured to recommend one or more alterations to the advertisement contextual schedule data based on a historical data of the proof of performance report using at least one of a first prediction model and a second prediction model. In an embodiment, the prediction unit 212 may be configured to determine a necessity to recommend the one or more alterations to the advertisement contextual schedule data based on the historical data of the proof of performance report using the first prediction model. In an embodiment, the prediction unit 212 may be configured to predict the advertisement product taxonomy and the one or more advertisement provider for each of the plurality of digital screens using the second prediction model.

The prediction unit 212 may be configured to determine a relevance of the scheduling data based on the generated advertisement contextual schedule data. The prediction unit 212 may be configured to maximize advertising revenue and filling advertisement inventory based on the generated advertisement contextual schedule data.

The updation unit 214 comprises suitable logic, circuitry, interfaces, and/or code that may be configured to update the advertisement contextual schedule data based on the recommended one or more alterations. The updation unit 214 may be configured to transmit interaction data associated with an activity of one or more target audiences on each of the plurality of digital screens to the one or more advertisement provider and analyze the interaction data to update the advertisement contextual schedule data.

The updation unit 214 may provide the optimized or updated Ad schedule to the plurality of digital screens 108. In an embodiment, the optimized Ad schedule may further comprise the screen ID corresponding to the updated Ad schedule. In an example, it may be scheduled that between 9 am to 10 am there are 2 slots of 10 secs each in a digital screen 08a. The updation unit 214 may build a reference that only 5 second duration Ads are being served during these slots. It is more likely that if the number of slots is increased (make 4 slots of 5 secs each), it is possible that more Ads will get served thus increasing the ROI. In another example, it may be scheduled that between 10 am and 11 am, there are 2 slots of 10 secs each. The updation unit 214 may build a reference that only 1 slot is fulfilled. However, between 11 am and 12 pm, there is a likelihood that more Ads are served than the available slots. Thus, the updation unit 214 can take a decision to move one slot in the schedule from 10 am to 11 am to the schedule of 11 am to 12 pm.

The audience unit 216 comprises suitable logic, circuitry, interfaces, and/or code that may be configured to segment and label the audience data based on demographic information of target audience. The audience unit 216 may be further configured to prepare an audience taxonomy corresponding to each of the plurality of digital screens based on the segmented and labelled audience data.

The AD performance generation unit 218 comprises suitable logic, circuitry, interfaces, and/or code that may be configured to generate a proof of performance report associated with the one or more advertisements. The AD performance generation unit 218 may be configured to generate the proof of performance report associated with each of the one or more advertisements for each of the advertisement provider. In an embodiment, AD performance generation unit 218 may monitor the type of Ad that got rendered to the plurality of digital screens 108 vis-à-vis what has been requested in an Ad request from the AD providers.

In an exemplary operation, the transceiver 206 may be configured to obtain one or more attributes associated with each of the plurality of digital screens 108. In an embodiment, the one or more attributes comprise a screen identifier, a screen size, a resolution, an orientation, a location, and a position associated with each of the plurality of digital screens. Further, the database server 102 may be configured to store the one or more attributes associated with each of the plurality of digital screens 108 of the digital signage network in a database.

After obtaining the one or more attributes, the transceiver 206 may be further configured to receive the scheduling data associated with the one or more advertisements. Further, the audience unit 216 may be configured to segment and label the audience data based on demographic information of target audience. In an embodiment, the audience data may be received from the advertisement server 102. The audience unit 216 may be configured to prepare an audience taxonomy corresponding to each of the plurality of digital screens 108 based on the segmented and labelled audience data. The audience taxonomy may be a way of categorizing audiences for segmenting and labelling of audience data based on audience's age range, gender, interest, and the like. The audience taxonomy may include, but not limited to, age range, gender, interest, and screen ID.

The audience unit 216 may be configured to interact with the smart interfaces associated with plurality of digital screens 108 to collect data (such data may be through live smart camera feed and/or audience metrics collected historically). The audience unit 216 may provide the data to the AD performance generation unit 218.

The AD performance generation unit 218 may be configured to generate a proof of performance report associated with the one or more advertisements. In an embodiment, the screen owner and/or the advertisement provider may generate one or more rules. The one or more rules may be fed to the each of the plurality of digital screens 108. The one or more rules may be about, for example a priority assigned to an advertisement or advertisement provider based on parameters like cost/price paid by the advertisement provider historically for a particular advertisement slot, contextual/non-contextual Ad, and the like. Such rules may be defined based on the user input and the plurality of factors. The AD performance generation unit 218 may be configured to generate one or more rules for prioritizing the one or more advertisement providers based on a user input and a plurality of factors.

In an embodiment, the user input and the plurality of factors are indicative of maximization of Return on Investment (RoI) for the one or more advertisement providers and owners associated with each of the plurality of digital screens. In an embodiment, the user input comprises a priority associated with each of the one or more advertisement providers, and a price for display of each of the one or more advertisements for a time duration. In an embodiment, the plurality of factors comprises a priority assigned to the one or more advertisement providers, a historical price paid by each of the one or more advertisement providers for each time instant, a time duration of the one or more advertisements, contextual relevance to location of each of the plurality of digital screens.

Further, the plurality of digital screens 108 may be configured to share with the AD performance generation unit 218 of the application server 104, the metrics of advertisement delivery from advertisement providers for all advertisement requests, advertisement playback on the plurality of digital screens 108 and advertisement performance against the advertisement request. The AD performance generation unit 218 uses these metrics for preparing the Proof of Performance (POP) Report for each advertisement request.

The AD performance generation unit 218 may be configured to receive the Proof of Performance (POP) Report containing the metrics of advertisement delivery from advertisement Providers for all advertisement requests, advertisement playback on the plurality of digital screens 108 and advertisement performance against the advertisement request. The AD performance generation unit 218 may be configured to monitor the type of advertisement that got rendered to the plurality of digital screens 108 vis-à-vis what has been requested in the advertisement request. In an embodiment, following metrics are included in the POP report:
Screen ID (MAC address of the digital screen)
Ad Provider ID
Venue (Physical location of digital screen, for example a mall)
Zone (Physical location within Venue)
Location (Logical division within Zone)
Screen Group (Grouping of digital screen at a Location)
Ad Start time (Start time of an Ad which was served to the digital screen).
Ad End time (End time of an Ad which was served to the digital screen)
Time Zone (Standard time zone like PST, IST etc.)
Ad availability (whether the Ad was served or not by the Ad Provider)
Ad slot length (Length of the slot for which an Ad was requested).
Ad Product Taxonomy (This Ad Taxonomy was returned by the Ad Provider)
Ad buffer time (how much time it is taking for the Ad to be delivered to the screen)

As illustrated above, in an embodiment, the metrics may comprise, but not limited to, the screen ID (MAC address of the DOOH Screen), the Ad provider ID, a venue (Physical location of DOOH Screen, for example a mall), a zone (Physical location within venue), a location (logical division within the zone), a screen group (grouping of screens at a location), Ad start time (start time of an Ad which was served to the DOOH screen), Ad end time (end time of an Ad which was served to the DOOH screen), a time zone (standard time zone like PST, IST etc.), availability of an Ad (whether the Ad was served or not by the Ad Provider), an Ad slot length (length of the slot for which an Ad was requested), an Ad Product taxonomy (The Ad product taxonomy was returned by the Ad Provider), and an Ad buffer time (how much time it is taking for the Ad to be delivered to the DOOH screen).

Further, the AD performance generation unit 218 of the application server 104 may be configured to generate the Advertisement Performance Report (APR) for each advertisement providers.

The APR report may comprise, but not limited to, an Ad provider ID, an Ad product taxonomy (shared with the Ad provider in the Ad request), an Ad product taxonomy (returned by the Ad provider in the response to the digital Screen), a probability of the Ad provider (based on previous data from the Ad provider giving an Ad).

Further, the AD context evaluator unit 210 may be configured to generate advertisement contextual schedule data associated with the one or more advertisements for the plurality of digital screens of the digital signage network based on the advertisement product taxonomy, the proof of performance report, the one or more attributes, Advertisement Performance Report (APR), and the scheduling data. In an embodiment, the advertisement contextual schedule data comprises advertisement product taxonomy, one or more advertisement provider for each of the plurality of digital screens, a corresponding advertisement time duration for the one or more advertisement provider, and a time instant for displaying the one or more advertisements. In an example, an optimized Ad schedule may be received for each digital screen from the AD context evaluator unit 210. The optimized Ad schedule may comprise, but not limited to, an updated Ad schedule and a screen ID. The AD context evaluator unit 210 may be configured to select at least one of a set of advertisement providers from the one or more advertisement providers, a type of advertisement for at least one of the plurality of digital screens of a digital signage network, a time duration, and a time instant for displaying the one or more advertisements. The prediction unit 212 may be configured to determine a relevance of the scheduling data based on the generated advertisement contextual schedule data using a predictive model. In an embodiment, the scheduling data comprises a time duration, a time instant, date of advertising, and a week of advertising. In an embodiment, the predictive model may be based on historical data how in a specific slot in a schedule the Ads were served to the specific digital screen. The predictive model may predict the changes in the scheduled slots and frequency of the Ad slot itself. Based on the prediction received from the predictive unit 212, the AD context evaluator unit 210 may update the Ad schedule related to each digital screen and may prepare the optimized Ad schedule.

The updation unit 214 may be configured to recommend one or more alterations to the advertisement contextual schedule data based on a historical data of the proof of performance report using at least one of a first prediction model and a second prediction model. In an embodiment, the prediction unit 212 may be configured to determine a necessity to recommend the one or more alterations to the advertisement contextual schedule data based on the historical data of the proof of performance report using the first prediction model. In an embodiment, the prediction unit 212 may be configured to predict the advertisement product taxonomy and the one or more advertisement provider for each of the plurality of digital screens using the second prediction model.

In an embodiment, the historical data is indicative of a schedule of the one or more advertisements displayed on the plurality of digital screens across one or more time durations at one or more time instants. In an embodiment, one or more alterations comprise an increase in a time duration of the one or more advertisements, decrease in the time duration of the one or more advertisements, a change in time instant for displaying the one or more advertisements, a change in the one or more advertisement provider, and a frequency associated with the displaying of the one or more advertisements. The updation unit 214 may be configured to update the advertisement contextual schedule data based on the recommended one or more alterations. The updation unit 214 may be configured maximize advertising revenue and filling advertisement inventory based on the generated advertisement contextual schedule data. To further clarify, advertisement contextual schedule data initially includes the normal schedule and this normal schedule is altered/updated based on the analysis to provide the optimized schedule, the product taxonomy and other details of the optimized schedule.

Once the advertisement contextual schedule data is updated, the transceiver 206 may provide the one or more advertisements to the plurality of digital screens 108 of the digital signage network based on the contextual advertisement schedule data. The plurality of digital screens may be configured to display the one or more advertisements on the plurality of digital screens of the digital signage network.

After the one or more advertisements are displayed on the plurality of digital screens 108, the plurality of digital screens 108 may be configured to transmit interaction data associated with an activity of one or more target audiences on each of the plurality of digital screens 108 to the application server 104 of each of the one or more advertisement provider. Further, the digital screens may provide the Ad requests to the advertisement server 102. An Ad request contains Ad provider ID, Ad product taxonomy, and screen ID. The advertisement server 102 may respond with an Ad response including Ad URL as well as the Ad product taxonomy (this Product Taxonomy could be different from the one provided in the Ad request) to the digital screen 108. Once the Ad is played, the digital screen may publish the POP report.

The updation unit 214 may be configured to analyze the interaction data to update the advertisement contextual schedule data. In an embodiment, the interaction data being captured using at least one of computer vision & Artificial Intelligence (AI) techniques. In an embodiment, the interaction data comprises number of viewers in front of the plurality of digital screens, viewers looked at the plurality of digital screens screen at least once, a sum of the watching time of all the watchers, an average dwelling time of all viewers, an attraction ratio, a gender split, and an age split.

Let us consider a practical scenario to illustrate the working of the present disclosure. Assume a digital signage network deployed in a shopping mall with multiple digital screens strategically placed in various locations such as entrance areas, hallways, and near popular stores. In an embodiment, each screen is equipped with sensors to gather attributes like screen size, resolution, and location. However, the functioning of the present disclosure is not limited to each screen being equipped with sensors.

Now, a marketing agency wants to run a campaign for a new product launch across these screens. They provide the content comprising advertisements and scheduling data to the system. The system's processor, utilizing the stored executable instructions, generates proof of performance reports based on historical data associated with the advertisements.

Using this information, the system generates contextual advertisement schedule data tailored to each screen. For instance, screens near fashion stores might display ads for clothing brands, while screens near food courts might show ads for restaurants. The system also considers factors like audience demographics, time of day, and previous advertisement performance to optimize the schedule.

Throughout the campaign, the system continuously monitors interaction data captured by the screens' sensors, such as the number of viewers, dwell time, and gender/age demographics. It uses this data to further refine the advertisement schedule, making real-time adjustments to maximize engagement and ROI for both advertisers and screen owners.

In this example, the system efficiently manages and delivers advertisements across the digital signage network, ensuring that the right content is displayed on the right screens at the right time, ultimately enhancing the effectiveness of the advertising campaign.

Let us delve into a detailed working example of the present disclosure.

Scenario: Assume a digital signage network installed in a busy airport. The network consists of 10 digital screens strategically located in different areas such as check-in counters, departure gates, and baggage claim areas. The goal is to efficiently manage advertisements on these screens to maximize revenue and engagement.

### Parameters and Values:

### 1. Attributes of Digital Screens:

Screen 1: Location—Check-in Counter, Size-55 inches, Resolution—1920×1080, Orientation—Landscape
Screen 2: Location—Departure Gate 1, Size-65 inches, Resolution—3840×2160, Orientation—Landscape
Screen 3: Location—Baggage Claim, Size-70 inches, Resolution—3840×2160, Orientation—Landscape
(and so on for each screen)

### 2. Advertisement Content:

Ad 1: Brand-XYZ Airlines, Duration—30 seconds, Target Audience—Travelers
Ad 2: Brand-ABC Hotel, Duration—20 seconds, Target Audience—Passengers waiting for boarding
Ad 3: Brand-FoodMart, Duration—15 seconds, Target Audience—Passengers waiting at baggage claim
(and so on for each advertisement)
   3. Scheduling Data (Initial Scheduling Data which is Created by the Operator/Admins of Digital Screens):
Ad 1: Time Slot—8:00 AM-10:00 AM, Location—Departure Gate 1
Ad 2: Time Slot—10:00 AM-12:00 PM, Location—Check-in Counter
Ad 3: Time Slot—12:00 PM-2:00 PM, Location—Baggage Claim
(and so on for each advertisement)

### 4. Performance Factors:

Viewer Engagement: Number of viewers, Dwell time, Interaction rate.
Advertisement Performance: Click-through rate, Conversion rate, Brand recall

The system gathers attributes of each digital screen, including location, size, resolution, and orientation, and stores them in a database. One or more operators or admins of each digital screens provide scheduling data to the system. For example, XYZ Airlines Ad 1 to be displayed at Departure Gate 1 from 8:00 AM to 10:00 AM.

The system monitors viewer engagement and advertisement performance in real-time using sensors and historical data. For instance, it tracks the number of viewers at each screen, their dwell time, and interaction with displayed ads. Based on the gathered data, the system generates a contextual advertisement schedule. Ad 2 (ABC Hotel) might be scheduled during peak travel hours at the check-in counter, while Ad 3 (FoodMart) could be displayed during baggage claim times.

The system continuously optimizes the advertisement schedule based on factors like audience demographics, time of day, and previous performance. If Ad 1 (XYZ Airlines) shows low engagement during its scheduled slot, the system may recommend adjusting the time or location for better results.

Throughout the campaign, the system provides real-time reports to advertisers, showing key metrics such as engagement rates, click-through rates, and return on investment (ROI). By efficiently managing advertisement content on the digital signage network, the system ensures that advertisers reach their target audience effectively while maximizing revenue for screen owners.

Another detailed working example to illustrate the optimization and adjustment process of the present disclosure is discussed herein.

Let us consider a digital signage network installed in a busy metropolitan transportation hub, consisting of screens at various locations such as ticket counters, waiting areas, and platforms. The goal is to optimize advertisement delivery for different demographics and maximize revenue for both advertisers and the network operator.

Attributes Gathering: The system gathers attributes for each screen:
Screen 1: Located at the ticket counter, large size (60 inches), high resolution (4K), landscape orientation.
Screen 2: Positioned in the waiting area, medium size (40 inches), standard resolution (1080p), portrait orientation.
Screen 3: Placed on the platform, small size (32 inches), standard resolution (1080p), landscape orientation.

Advertisement Content and Scheduling: A beverage company wants to advertise its new energy drink during rush hours. They provide the advertisement content and, specifying the target demographics. The digital screen operator/admins creates the initial scheduling data as below:
Morning Rush (7:00 AM-9:00 AM): Targeting commuters aged 18-35.
Evening Rush (5:00 PM-7:00 PM): Targeting commuters aged 25-50.

Optimization and Adjustment: The system analyzes the attributes of each screen and the demographics of commuters in different areas of the transportation hub. The system schedules the energy drink ad to play on Screen 1 during the morning rush, targeting younger commuters at the ticket counter who might be interested in a quick energy boost. Using demographic data from previous interactions, the system segments the audience into groups based on age and gender. The system schedules the ad to play on Screen 2 during the evening rush, targeting middle-aged commuters in the waiting area who may be more receptive to the product.

Throughout the day, the system collects interaction data from each screen, including the number of viewers, dwell time, and engagement metrics. If the morning rush ad on Screen 1 receives lower-than-expected engagement from the target demographic, the system dynamically adjusts the schedule. The system increases the frequency of the ad or shifts it to a different time slot to optimize reach and engagement. The system continuously monitors the performance of each advertisement based on metrics like viewer interaction and conversion rates. If the energy drink ad consistently outperforms other ads, the system allocates more screen time and premium slots to maximize revenue for the advertiser and the network operator.

By dynamically optimizing advertisement delivery based on contextual relevance, audience segmentation, and real-time adjustments, the system ensures that the energy drink ad reaches the right audience at the right time, maximizing engagement and ROI for the advertiser and enhancing the overall effectiveness of the digital signage network.

A person skilled in the art will understand that the scope of the disclosure is not limited to smart programmatic advertisement scheduling on the plurality of digital screens 108 of the digital signage network based on the aforementioned factors and using the aforementioned techniques, and that the examples provided do not limit the scope of the disclosure.

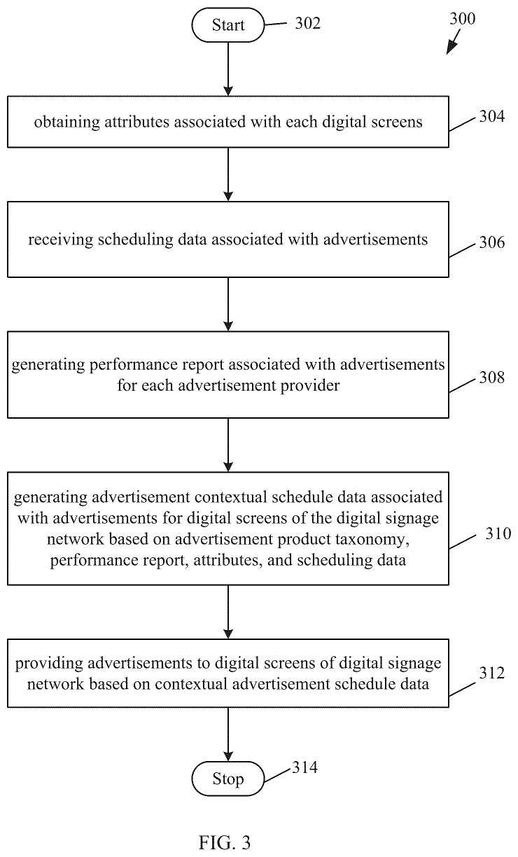

FIG. 3 is a flowchart that illustrates a method for smart programmatic advertisement scheduling on a plurality of digital screens of a digital signage network, in accordance with an embodiment of present invention. The method begins in a Start step 302 and proceeds to a step 304.

At step 304, the application server is configured to obtain one or more attributes associated with each of the plurality of digital screens. At step 306, the application server is configured to receive the scheduling data associated with the one or more advertisements. At step 308, the application server is configured to generate a proof of performance report associated with the one or more advertisements.

At step 310, the application server is configured to generate advertisement contextual schedule data associated with the one or more advertisements for the plurality of digital screens of the digital signage network based on the advertisement product taxonomy, the proof of performance report, the one or more attributes, and the scheduling data. At step 312, the application server is configured to provide the one or more advertisements to the plurality of digital screens of the digital signage network based on the contextual advertisement schedule data. Control passes to end step 314.

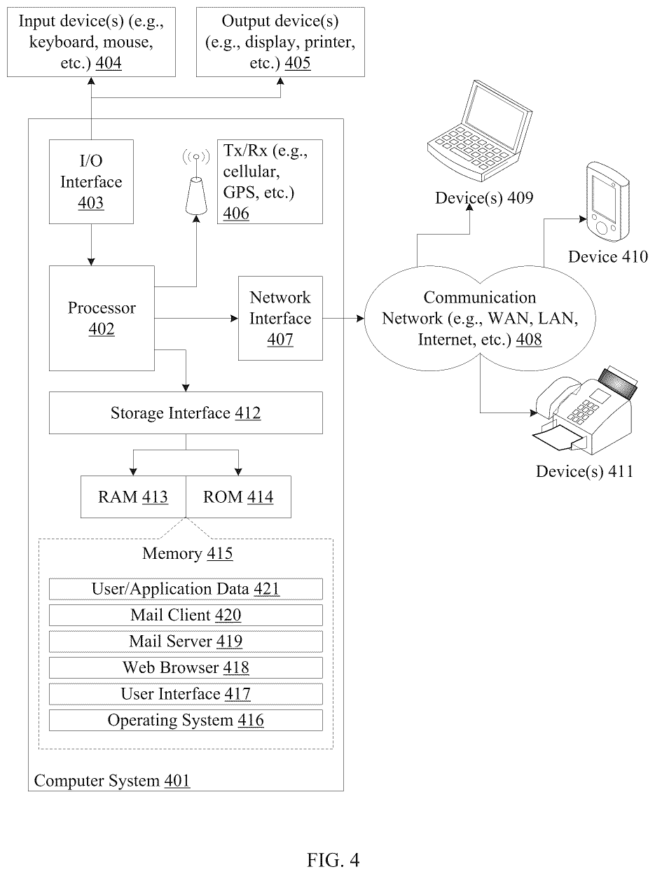

FIG. 4 illustrates a block diagram of an exemplary computer system 401 for implementing embodiments consistent with the present disclosure.

Variations of computer system 401 may be used for performing optical character recognition on an image including a plurality of printed characters. The computer system 401 may comprise a central processing unit (“CPU” or “processor”) 402. The processor 402 may comprise at least one data processor for executing program components for executing user- or system-generated requests. A user may include a person, a person using a device such as such as those included in this disclosure, or such a device itself. Additionally, the processor may include specialized processing units such as integrated system (bus) controllers, memory management control units, floating point units, graphics processing units, digital signal processing units, or the like. In various implementations the processor 402 may include a microprocessor, such as AMD Athlon, Duron or Opteron, ARM's application, embedded or secure processors, IBM PowerPC, Intel's Core, Itanium, Xeon, Celeron or other line of processors, for example. Accordingly, the processor 402 may be implemented using mainframe, distributed processor, multi-core, parallel, grid, or other architectures. Some embodiments may utilize embedded technologies like application-specific integrated circuits (ASICs), digital signal processors (DSPs), or Field Programmable Gate Arrays (FPGAs), for example.

Processor 402 may be disposed in communication with one or more input/output (I/O) devices via I/O interface 403. Accordingly, the I/O interface 403 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like, for example.

Using the I/O interface 403, the computer system 401 may communicate with one or more I/O devices. For example, the input device 404 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, or visors, for example. Likewise, an output device 405 may be a printer, fax machine, video display (e.g., cathode ray tube (CRT), liquid crystal display (LCD), light-emitting diode (LED), plasma, or the like), or audio speaker, for example. In some embodiments, a transceiver 406 may be disposed in connection with the processor 402. The transceiver 406 may facilitate various types of wireless transmission or reception. For example, the transceiver 406 may include an antenna operatively connected to a transceiver chip (example devices include the Texas Instruments® WiLink WL1283, Broadcom® BCM4750IUB8, Infineon Technologies® X-Gold 618-PMB9800, or the like), providing IEEE 802.11a/b/g/n, Bluetooth, FM, global positioning system (GPS), and/or 2G/3G/5G/6G HSDPA/HSUPA communications, for example.

In some embodiments, the processor 402 may be disposed in communication with a communication network 408 via a network interface 407. The network interface 407 is adapted to communicate with the communication network 408. The network interface 407 may employ connection protocols including, without limitation, direct connect, Ethernet (e.g., twisted pair 10/100/1000 Base T), transmission control protocol/internet protocol (TCP/IP), token ring, or IEEE 802.11a/b/g/n/x, for example. The communication network 408 may include, without limitation, a direct interconnection, local area network (LAN), wide area network (WAN), wireless network (e.g., using Wireless Application Protocol), or the Internet, for example. Using the network interface 407 and the communication network 408, the computer system 401 may communicate with devices such as shown a mobile/cellular phone 410, a Point of Sale Terminal 411, or a laptop 409. Other exemplary devices may include, without limitation, personal computer(s), server(s), fax machines, printers, scanners, various mobile devices such as cellular telephones, smartphones (e.g., Apple iphone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 401 may itself embody one or more of these devices.

In some embodiments, the processor 402 may be disposed in communication with one or more memory devices (e.g., RAM 413, ROM 414, etc.) via a storage interface 412. The storage interface 412 may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, or solid-state drives, for example.

The memory devices may store a collection of program or database components, including, without limitation, an operating system 416, user interface application 417, web browser 418, mail server 419, mail client 420, user/application data 421 (e.g., any data variables or data records discussed in this disclosure) for example. The operating system 416 may facilitate resource management and operation of the computer system 401. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple IOS, Google Android, Blackberry OS, or the like.

A user interface 417 if for facilitating the display, execution, interaction, manipulation, or operation of program components through textual or graphical facilities. For example, user interfaces may provide computer interaction interface elements on a display system operatively connected to the computer system 401, such as cursors, icons, check boxes, menus, scrollers, windows, or widgets, for example. Graphical user interfaces (GUIs) may be employed, including, without limitation, Apple Macintosh operating systems' Aqua, IBM OS/2, Microsoft Windows (e.g., Aero, Metro, etc.), Unix X-Windows, or web interface libraries (e.g., ActiveX, Java, Javascript, AJAX, HTML, Adobe Flash, etc.), for example.

In some embodiments, the computer system 401 may implement a web browser 418 stored program component. The web browser 418 may be a hypertext viewing application, such as Microsoft Internet Explorer, Google Chrome, Mozilla Firefox, Apple Safari, or Microsoft Edge, for example. Secure web browsing may be provided using HTTPS (secure hypertext transport protocol), secure sockets layer (SSL), Transport Layer Security (TLS), or the like. Web browsers may utilize facilities such as AJAX, DHTML, Adobe Flash, JavaScript, Java, or application programming interfaces (APIs), for example. In some embodiments the computer system 401 may implement a mail server 419 stored program component. The mail server 419 may be an Internet mail server such as Microsoft Exchange, or the like. The mail server may utilize facilities such as ASP, ActiveX, ANSI C++/C#, Microsoft.NET, CGI scripts, Java, JavaScript, PERL, PHP, Python, or WebObjects, for example. The mail server 419 may utilize communication protocols such as internet message access protocol (IMAP), messaging application programming interface (MAPI), Microsoft Exchange, post office protocol (POP), simple mail transfer protocol (SMTP), or the like. In some embodiments, the computer system 401 may implement a mail client 4420 stored program component. The mail client 420 may be a mail viewing application, such as Apple Mail, Microsoft Entourage, Microsoft Outlook, or Mozilla Thunderbird.

In some embodiments, the computer system 401 may store user/application data 421, such as the data, variables, records, or the like as described in this disclosure. Such databases may be implemented as fault-tolerant, relational, scalable, secure databases such as Oracle or Sybase, for example. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

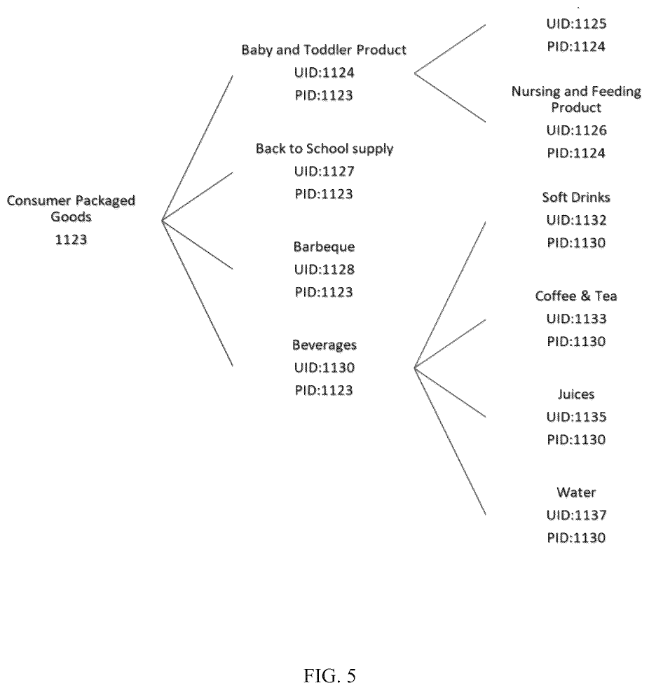

FIG. 5 illustrates an exemplary diagram of an Ad product taxonomy, in accordance with an embodiment of present invention.

The Ad product taxonomy may be a standardized nomenclature for describing the product or service being advertised on a screen. The Ad product taxonomy may provide Ad providers with a stronger control over the types of ads that get delivered to the DOOH screens. The Ad product taxonomy is a tiered structure which defines a unique ID (UID), Parent ID (PID), and Ad category name (Tier 1, Tier 2, Tier3, . . . ). Each Ad content can be defined with a unique UID/PID/Ad category name as illustrated in FIG. 5.

To represent what type of Ad has to be requested or type of Ad returned by the Ad Provider, the product taxonomy may be used. For e.g., if a request for an Ad for audience with babies, the context evaluator module 214 may construct an Ad Request with Ad Product Taxonomy as (1123, 1124, 1125), which represents (consumer package goods, baby toddler products, and diaper). Now the Ad served will have an Ad product taxonomy which may or may not match the requested Ad Product Taxonomy.

For E.g., Ad product taxonomy as (1123, 1124, 1126), which represents (Consumer Package Goods, Baby Toddler Products, Nursing and Feeding products). Comparing this it can be deduced how close the match is.

In an embodiment, the screen owner and/or the advertisement provider may generate one or more rules. define business rules that will be used in creating the Ad context information. During the initial onboarding of an Ad provider, the screen owners enter a contract with Ad providers wherein the prices for various slot schedules are negotiated.

For instance, a user can provide inputs to the user manager module as follows:
Rule 1: Prioritize an Ad provider with the highest price having relevant context.
Rule 2: Prioritize an Ad provider with the highest price with no context.
Rule 3: Prioritize an Ad provider having relevant context.
Rule 4: Prioritize an Ad provider with no context (maximize on Ad availability).

The audience unit may receive audience metrics may prepare an audience taxonomy corresponding to each of the digital screens 108. The audience taxonomy is a standard way of categorizing audiences for segmenting and labelling of audience data. It may the data, such as age range, gender, interest, and screen ID. In an embodiment, the audience taxonomy may be provided as an input to the AD Context evaluator unit 210 from the audience performance generation unit 218.

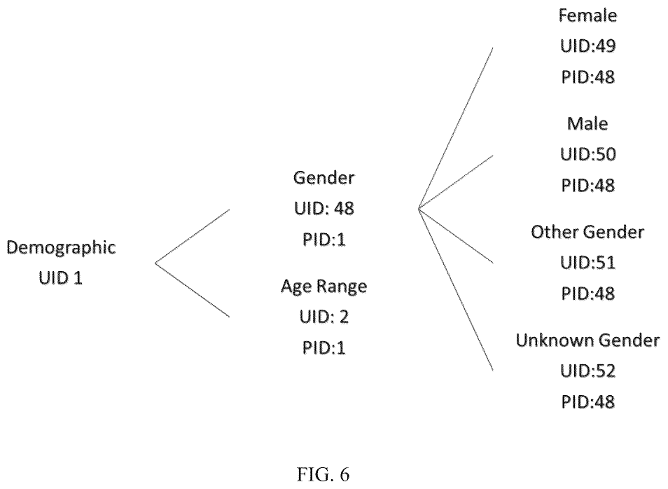

FIG. 6 illustrates an exemplary diagram of an audience taxonomy, in accordance with an embodiment of present invention.

The audience taxonomy may be a standard way of categorizing audiences for segmenting and labelling of audience data. The Ad audience taxonomy may be a tiered structure which defines a unique ID (UID), Parent ID (PID) and Ad category name (Tier 1, Tier 2, Tier3, . . . ). Each Ad content can be defined as with a unique UID/PID/Ad category name as illustrated in FIG. 6.

The audience unit 216 may convert the data received into a format understood by the AD Context evaluator unit 210 which is the audience taxonomy. For e.g., the system may give data like 55% Female and 45% Male audience are watchers for Screen X. The audience unit 216 may represent this in Audience Taxonomy 55% of (1,48,49) which represents (Demographic, Gender, Female) and 45% (1,48, 50) which represents (Demographic, Gender, Male).

Referring back to FIG. 6, the audience unit 216 may receive input (audience data) from smart interfaces (cameras installed at various screen locations) and may generate the audience metrics. The system may utilize computer vision & Artificial Intelligence (AI) driven solutions that provides high-fidelity impressions and audience engagement analytics. The audience metrics may include, but not limited to, a screen ID, Opportunity to See (OTS) (number of viewers in front of the digital screen), watchers (viewers looked at the digital screen at least once), conversion ratio (watchers/OTS), a total attention time (sum of the watching time of all the watchers), an average dwell time (average dwelling time of all viewers), an attraction ratio (total attention time/average dwell time), gender split, and age split.

The AD Context evaluator unit 210 is a core unit that is responsible for determining the Ad context that will be used by the application server to schedule the programmatic Ads efficiently. In an example, the Ad performance report may comprise, but not limited to, an Ad provider ID, an Ad product taxonomy (shared with the Ad provider in the Ad request), an Ad product taxonomy (returned by the Ad provider in the response to the digital Screen), and a probability of the Ad provider (based on previous data from the Ad provider giving an Ad).

In an example, one or more rules (including Ad provider IDs & screen IDs) about priority and cost of Ad providers may be received from the user manager module 208. In an example, the digital screen data may be received which may comprise, but not limited to, a screen ID, a size of the screen size, a resolution of the screen, an orientation of the screen (vertical or horizontal), a screen site location, and a position of the screen in the site associated with each of the plurality of digital screens.

In an example, the audience taxonomy may be received from the audience profile module 210. The audience taxonomy may include, but not limited to, age range, gender, interest, and screen ID. In an example, the optimized Ad schedule may be received from the day parting module 204 for each screen. The optimized Ad schedule may comprise, but not limited to, an updated Ad schedule and a screen ID. Further, the prediction unit may build an AI-based predictive model based on the historical data. For the above-mentioned received inputs, the AI-based predictive model may predict the Ad product taxonomy and the most efficient Ad Provider for all the digital screens for the scheduled slots.

Further, the AD Context evaluator unit 210 may output an Ad context data. The Ad context data may comprise, but not limited to, the Ad product taxonomy, the Ad provider ID, the Ad schedule (Ad slot), and the screen ID. In an embodiment, AD Context evaluator unit 210 may provide the Ad context data to a Content Management System (CMS). The CMS may be responsible for creating contextual Ad schedule data based on the Ad context data. The CMS may provide contextual Ad schedule data that contains optimized Ad schedules along with Ad ID and Ad provider ID to respective digital screens. The digital screens, then request Ads from Ad provider module. All the digital screens share with the CMS, the metrics of Ad delivery from Ad providers for all Ad requests, Ad playback on the digital screens and Ad performance against the Ad request. The CMS uses these metrics for preparing the POP report for each Ad request. The advertisement server 102 corresponding to each Ad providers provide advertisements to the digital screens. An Ad provider can either be an aggregator of Ad providers or an individual Ad provider. The Ad providers belong to programmatic Ad Ecosystem.

The advertisement server 102 associated with one or more advertisement providers may comprise of supply-side platforms (SSP) or sell-side platforms that are advertising technology (adtech) platform used to coordinate and manage the supply and distribution of ad inventories. The SSP may help digital media owners and publishers sell ad space. The SSP may be a key part of the real-time bidding (RTB) process within programmatic advertising, enabling publishers to optimize yield by simultaneously connecting their inventory to multiple ad exchanges and demand-side platforms (DSPs). By opening up impressions to as many potential buyers as possible, the publisher's site can maximize the revenue they receive for their inventory. For this reason, the SSP may be sometimes referred to as yield-optimization platforms.

The advertisement server 102 may manage, store and serve the Ads. The advertisement server 102 may maintain a database containing information, such as Ad IDs, Ad Lengths, Ad type, Ad Provider ID, Name of the Advertiser etc. In an embodiment, the advertisement server 102 may receive an Ad request from the digital screen. The Ad request may include the Ad ID, Ad Provider ID, Ad Product taxonomy, and the digital Screen ID. Based on the Ad request, the Ad provider module 218 may search into the database and returns an Ad content comprising Ad URL and Ad product taxonomy to the digital screens.

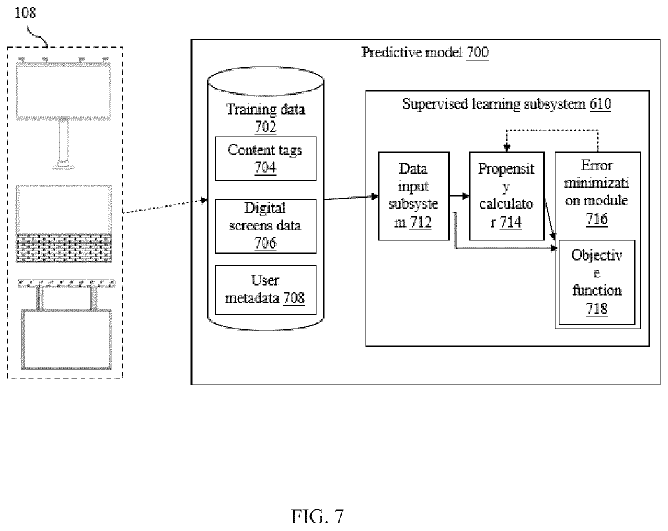

FIG. 7 illustrates a block diagram of a predictive model, according to an embodiment of present invention.

More specifically, in some embodiments, the predictive model 700 may be trained using training data 702. The training data 702 may be populated by data received from the digital screens 108. As described above, the predictive model 700 may be or include a non-binary classifier, such as a multinomial logistic regression model implemented in a neural network, trained to predict a probability that an input can be mapped to one or more classes of a set of classes, corresponding to content tags 704 or user characteristics from user metadata 708. As such, training the predictive model 700 may include applying a supervised learning technique using one or more labeled sets of training data 702, which may include content tags 704, digital screen data 706, and user metadata 708. The user metadata 708 may include user characteristics or other identifiers, such as anonymized identification numbers. The content tags 704 may be drawn from a database of features that the feature prediction models are trained to identify. As such, the content tags 704 may correspond to the features that may characterize content objects processed by the predictive model 700.

The training data may be provided to a supervised learning subsystem 710. For example, the supervised learning subsystem 710 may comprise a data input subsystem 712 to receive the training data 702. As part of supervised training, the supervised learning subsystem 710 may use the training data 702 to define a ground truth, such that elements defining a mapping of the content tags 704, the digital screen data 706, and user characteristics from the user metadata 708 are provided to a propensity calculator 714 and an error minimization module 716. The error minimization module 716 may, in turn, implement an objective function 718, which may be an error function, for example, defined as a distance between the model output and the ground truth. In this way, training may include adjusting one or more weights and/or coefficients of the propensity calculator 714 over multiple iterations until the value of the objective function converges to a global minimum.

In some embodiments, the input to the propensity calculator 714 includes the characteristics of a set of users, and the output includes a vector of probability values corresponding to predicted content features. In this way, the propensity calculator 714 may be trained to map the content tags 704 of the training data 702 to the user metadata 708 of the training data 702, and, once trained, the propensity calculator 714 may be used to generate the propensity score. As trained, the propensity calculator may be able to determine the propensity score indicative of the extent to which the user has propensity for releasing user's data to at least one digital platform.

In some embodiments, the supervised learning subsystem 710 may implement hyperparametric tuning, in addition to supervised learning, to optimize the predictive model 700. For example, one or more terms of the objective function 718 and/or the predictive model 700 may be fine-tuned by varying parameters that are not learned, such as scalar weighting factors.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Various embodiments of the disclosure encompass numerous advantages including methods and systems for smart programmatic advertisement scheduling on the plurality of digital screens of the digital signage network. The disclosed method and system has several technical advantages, but not limited to the following:

The system's dynamic content management capabilities enable precise scheduling and delivery of advertisements across the digital signage network. The system leverages real-time data on factors such as audience demographics, location, and time of day to dynamically adjust advertisement schedules. This ensures that the right content is displayed to the right audience at the most opportune moments, maximizing engagement and conversion rates. Through sophisticated audience segmentation techniques, the system can tailor content to specific demographics and audience preferences. By analyzing demographic information, interaction metrics, and other relevant data points, the system creates targeted advertisement schedules that resonate with different audience segments. This level of personalization enhances the relevance and effectiveness of advertisements, leading to higher viewer engagement and conversion rates.

The system employs advanced optimization techniques to maximize return on investment (ROI) for advertisers and digital signage network owners. These techniques analyze a wide range of factors, including advertisement performance metrics, historical data, user input, and market trends. By considering these variables, the system generates contextual advertisement schedules that optimize revenue generation while efficiently filling advertisement inventory. Real-time performance monitoring is a key feature of the system, allowing advertisers and network operators to track the effectiveness of advertisements as they are displayed. Performance metrics such as viewer engagement, dwell time, and conversion rates are continuously monitored and analyzed. Based on this real-time feedback, the system can make immediate adjustments to advertisement schedules, optimizing delivery for maximum impact and effectiveness.

The system's ability to capture and analyze interaction data using computer vision and artificial intelligence techniques provides valuable insights into viewer behavior and preferences. By analyzing metrics such as viewer demographics, attention levels, and interaction patterns, the system continuously refines its advertisement schedules and content strategies. This data-driven approach enables advertisers to make informed decisions and adapt their campaigns in real-time, leading to continuous improvement and optimization of the digital signage network.

In summary, these technical advantages empower advertisers and digital signage network operators to deliver highly targeted, engaging content to their audiences while maximizing ROI and continuously improving campaign performance.

The claimed invention of a system and a method for smart programmatic advertisement scheduling on digital screens within a digital signage network, involves tangible components, processes, and functionalities that interact to achieve specific technical outcomes. The system integrates various elements such as processors, memory, databases, real-time data analysis, audience segmentation techniques, and optimization algorithms to effectively manage and schedule advertisements on digital screens. These components work together to address practical technical challenges faced by advertisers and digital signage network operators, such as maximizing advertisement revenue, optimizing content delivery, and enhancing viewer engagement.

Furthermore, the invention involves a non-trivial combination of technologies and methodologies that provide a technical solution for a technical problem. While individual components like processors, databases, and real-time data analysis are well-known in the field of computer science, their integration into a comprehensive system for managing digital signage networks involves inventive steps. The invention's ability to dynamically adjust advertisement schedules based on real-time audience data, optimize content delivery for maximum ROI, and continuously improve campaign performance through data-driven insights represents technical advancement in the field of digital signage management.

Additionally, the present disclosure's reliance on advanced techniques such as audience segmentation, predictive modeling, and interaction analysis using computer vision and artificial intelligence further enhances the technical advancement. These technologies represent cutting-edge developments that require specialized knowledge and expertise to implement effectively. Therefore, the claimed invention is a concrete and technical solution that offers tangible benefits to advertisers, digital signage network operators, and viewers alike.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like. The claims can encompass embodiments for hardware and software, or a combination thereof.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A system for smart programmatic advertisement scheduling on a plurality of digital screens of a digital signage network, the system comprising:
a processor; and
a memory communicatively coupled to the processor, wherein the memory stores processor-executable instructions, which, on execution, causes the processor to:
obtain one or more attributes associated with each of the plurality of digital screens;
receive scheduling data associated with one or more advertisements;
generate a proof of performance report associated with the one or more advertisements
generate advertisement contextual schedule data associated with the one or more advertisements for the plurality of digital screens of the digital signage network based on advertisement product taxonomy, the performance report, the one or more attributes, and the scheduling data; and
provide the one or more advertisements to the plurality of digital screens of the digital signage network based on the contextual advertisement schedule data.

2. The system as claimed in claim 1, wherein the one or more attributes comprise a screen identifier, a screen size, a resolution, an orientation, a location, and a position associated with each of the plurality of digital screens.

3. The system as claimed in claim 1, wherein the processor is further configured to:
store the one or more attributes associated with each of the plurality of digital screens of the digital signage network in a database;
recommend one or more alterations to the advertisement contextual schedule data based on a historical data of the proof of performance report using at least one of: a first prediction model and a second prediction model, wherein the historical data is indicative of a schedule of the one or more advertisements displayed on the plurality of digital screens across one or more time durations at one or more time instants;
determine a necessity to recommend the one or more alterations to the advertisement contextual schedule data based on the historical data of the proof of performance report using the first prediction model;
predict the advertisement product taxonomy and the one or more advertisement provider for each of the plurality of digital screens using the second prediction model, wherein the one or more alterations comprise an increase in a time duration of the one or more advertisements, decrease in the time duration of the one or more advertisements, a change in time instant for displaying the one or more advertisements, a change in the one or more advertisement provider, and a frequency associated with the displaying of the one or more advertisements; and
update the advertisement contextual schedule data based on the recommended one or more alterations.

4. The system as claimed in claim 1, wherein the advertisement contextual schedule data comprises advertisement product taxonomy, one or more advertisement provider for each of the plurality of digital screens, a corresponding advertisement time duration for the one or more advertisement provider, and a time instant for displaying the one or more advertisements.

5. The system as claimed in claim 1, wherein the processor is further configured to:
segment and label the audience data based on demographic information of target audience; and
prepare an audience taxonomy corresponding to each of the plurality of digital screens based on the segmented and labelled audience data.

6. The system as claimed in claim 1, wherein the processor is further configured to:
generate the proof of performance report associated with each of the one or more advertisements for each of the advertisement provider based on one or more metrics of advertisement delivery from the one or more advertisement providers for the one or more advertisements, advertisement playback on the plurality of digital screens, and advertisement performance against the displaying of the one or more advertisements on the plurality of digital screens of the digital signage network; and
generate one or more rules for prioritizing the one or more advertisement providers based on a user input and a plurality of factors being indicative of maximization of Return on Investment (RoI) for the one or more advertisement providers and owners associated with each of the plurality of digital screens.

7. The system as claimed in claim 6, wherein the user input comprises a priority associated with each of the one or more advertisement providers, and a price for display of each of the one or more advertisements for a time duration, wherein the plurality of factors comprises a priority assigned to the one or more advertisement providers, a historical price paid by each of the one or more advertisement providers for each time instant, a time duration of the one or more advertisements, contextual relevance to location of each of the plurality of digital screens.

8. The system as claimed in claim 1, wherein the processor is further configured to:
select at least one of a set of advertisement providers from the one or more advertisement providers, a type of advertisement for at least one of the plurality of digital screens of a digital signage network, a time duration, and a time instant for displaying the one or more advertisements;
determine a relevance of the scheduling data based on the generated advertisement contextual schedule data, and wherein the scheduling data comprises a time duration, a time instant, date of advertising, and a week of advertising;
transmit interaction data associated with an activity of one or more target audiences on each of the plurality of digital screens to the one or more advertisement provider; and
analyze the interaction data to update the advertisement contextual schedule data, wherein the interaction data being captured using at least one of computer vision & Artificial Intelligence (AI) techniques, wherein the interaction data comprises number of viewers in front of the plurality of digital screens, viewers looked at the plurality of digital screens screen at least once, a sum of the watching time of all the watchers, an average dwelling time of all viewers, an attraction ratio, a gender split, and an age split.

9. The system as claimed in claim 1, wherein the processor is further configured to display the one or more advertisements on the plurality of digital screens of the digital signage network.

10. A method for smart programmatic advertisement scheduling on a plurality of digital screens of a digital signage network, the method comprising:
obtaining, by a processor, one or more attributes associated with each of the plurality of digital screens;
receiving, by the processor, scheduling data associated with one or more advertisements;
generating, by the processor, a proof of performance report associated with the one or more advertisements;
generating, by the processor, advertisement contextual schedule data associated with the one or more advertisements for the plurality of digital screens of the digital signage network based on advertisement product taxonomy, the performance report, the one or more attributes, and the scheduling data; and
providing, by the processor, the one or more advertisements to the plurality of digital screens of the digital signage network based on the contextual advertisement schedule data.

11. The method as claimed in claim 10, wherein the one or more attributes comprise a screen identifier, a screen size, a resolution, an orientation, a location, and a position associated with each of the plurality of digital screens.

12. The method as claimed in claim 10, further comprising:
storing the one or more attributes associated with each of the plurality of digital screens of the digital signage network in a database;
recommending one or more alterations to the advertisement contextual schedule data based on a historical data of the proof of performance report using at least one of a first prediction model and a second prediction model, wherein the historical data is indicative of a schedule of the one or more advertisements displayed on the plurality of digital screens across one or more time durations at one or more time instants;
determining a necessity to recommend the one or more alterations to the advertisement contextual schedule data based on the historical data of the proof of performance report using the first prediction model;
predicting the advertisement product taxonomy and the one or more advertisement provider for each of the plurality of digital screens using the second prediction model, wherein the one or more alterations comprise an increase in a time duration of the one or more advertisements, decrease in the time duration of the one or more advertisements, a change in time instant for displaying the one or more advertisements, a change in the one or more advertisement provider, and a frequency associated with the displaying of the one or more advertisements; and
updating the advertisement contextual schedule data based on the recommended one or more alterations.

13. The method as claimed in claim 10, wherein the advertisement contextual schedule data comprises advertisement product taxonomy, one or more advertisement provider for each of the plurality of digital screens, a corresponding advertisement time duration for the one or more advertisement provider, and a time instant for displaying the one or more advertisements.

14. The method as claimed in claim 10, further comprising:
segmenting and labelling the audience data based on demographic information of target audience; and
preparing an audience taxonomy corresponding to each of the plurality of digital screens based on the segmented and labelled audience data.

15. The method as claimed in claim 10, further comprising:
generating the proof of performance report associated with each of the one or more advertisements for each of the advertisement provider based on one or more metrics of advertisement delivery from the one or more advertisement providers for the one or more advertisements, advertisement playback on the plurality of digital screens, and advertisement performance against the displaying of the one or more advertisements on the plurality of digital screens of the digital signage network;
generating one or more rules to prioritize the one or more advertisement providers based on a user input and a plurality of factors being indicative of maximization of Return on Investment (RoI) for the one or more advertisement providers and owners associated with each of the plurality of digital screens,

16. The method as claimed in claim 15, wherein the user input comprises a priority associated with each of the one or more advertisement providers, and a price for display of each of the one or more advertisements for a time duration, wherein the plurality of factors comprises a priority assigned to the one or more advertisement providers, a historical price paid by each of the one or more advertisement providers for each time instant, a time duration of the one or more advertisements, contextual relevance to location of each of the plurality of digital screens.

17. The method as claimed in claim 10, further comprising:
selecting at least one of a set of advertisement providers from the one or more advertisement providers, a type of advertisement for at least one of the plurality of digital screens of a digital signage network, a time duration, and a time instant for displaying the one or more advertisements;
determining a relevance of the scheduling data based on the generated advertisement contextual schedule data, and wherein the scheduling data comprises a time duration, a time instant, date of advertising, and a week of advertising;
transmitting interaction data associated with an activity of one or more target audiences on each of the plurality of digital screens to the one or more advertisement provider; and
analyzing the interaction data to update the advertisement contextual schedule data, wherein the interaction data being captured using at least one of computer vision & Artificial Intelligence (AI) techniques.

18. The method as claimed in claim 17, wherein the interaction data comprises number of viewers in front of the plurality of digital screens, viewers looked at the plurality of digital screens screen at least once, a sum of the watching time of all the watchers, an average dwelling time of all viewers, an attraction ratio, a gender split, and an age split.

19. The method as claimed in claim 10, further comprising displaying the one or more advertisements on the plurality of digital screens of the digital signage network.

20. A non-transitory computer-readable storage medium having stored thereon, a set of computer-executable instructions for causing a computer comprising one or more processors to perform steps comprising:
obtaining one or more attributes associated with each of the plurality of digital screens;
receiving scheduling data associated with one or more advertisements;
generating a proof of performance report associated with the one or more advertisements;
generating advertisement contextual schedule data associated with the one or more advertisements for the plurality of digital screens of the digital signage network based on advertisement product taxonomy, the performance report, the one or more attributes, and the scheduling data; and
providing the one or more advertisements to the plurality of digital screens of the digital signage network based on the contextual advertisement schedule data.
